(19) United States
(12) Patent Application Publication
(10) Pub. No.: US 2025/0075746 A1
(43) Pub. Date: Mar. 6, 2025

(54) SAFETY COUPLING

(71) Applicant: R+W Antriebselemente GmbH, Woerth a. Main (DE)

(72) Inventor: Joerg DUGGEN, Woerth am Main (DE)

(73) Assignee: R+W Antriebselemente GmbH, Woerth a. Main (DE)

(21) Appl. No.: 18/632,348

(22) Filed: Apr. 11, 2024

Related U.S. Application Data
(63) Continuation of application No. PCT/DE2022/150005, filed on Oct. 11, 2022.

(30) Foreign Application Priority Data
Oct. 11, 2021 (EP) 21401041.5
Jul. 14, 2022 (EP) 22185066.2

(51) Int. Cl. F16D 7/10

(52) U.S. Cl. CPC F16D 7/10

(57) ABSTRACT

A safety coupling is disclosed that disengages from a drive position into a freewheel mode when an adjustable overload torque is exceeded. The coupling includes a driving flange (10) rotatable about a common axis of rotation, featuring circumferentially distributed recesses (12) on a hole circle, and a driven coupling part (20) also rotatable about the same axis. Switch segments (40) in the coupling part (20) press detent elements (30) into the recesses under spring force in the drive position, creating a rotational connection between the flange (10) and the coupling part (20). Upon exceeding the overload torque, the detent elements (30) are displaced from the recesses against the spring force, disengaging the connection and enabling freewheel operation. The flange (10) serves as an inner ring paired with a bearing support (50), the coupling part (20) as an outer ring, and rolling elements (52) are positioned between the rings.

### CROSS-REFERENCE TO RELATED APPLICATIONS

This application is a continuation of international (WO) patent application no. PCT/DE2022/150005, filed 11 Oct. 2022, which claims the respective priority—of European patent (EP) application no. 21 401 041.5, filed 11 Oct. 2021, and—of European patent (EP) application no. 22 185 066.2, filed 14 Jul. 2022, the respective contents of each being hereby incorporated herein by reference.

### FIELD OF THE INVENTION

The present invention basically relates to the technical field of safety couplings; in particular, the present invention relates to a safety coupling disengaging from a drive position into a freewheel when an adjustable overload torque is exceeded in the event of an overload. Finally, the present invention relates to the use of at least one such device.

### BACKGROUND OF THE INVENTION

Safety couplings of this type are known in a variety of embodiments (DE 197 39 469 A1; DE 101 43 583 A1; DE 10 2006 050 995 A1).

A known safety coupling of this type has in the drive position no relative rotational movement between the flange and the coupling part. In the event of an overload, i.e. when an adjustable overload torque is exceeded, the safety coupling disengages from the drive position into the freewheel, in which it has a relative rotational movement in one direction of rotation to the flange and in which it remains until the reset. In this case, the driven part will come to a standstill due to the force-locking connection to the connected load and will no longer continue to rotate, whereas the driving part will continue to rotate, which is why the relative movement is set in the one direction of rotation mentioned.

With regard to the state of the art, attention is further drawn to the publications DE 20 2019 003 203 U1, DE 10 2020 126 988 A1 (=FR 3 102 816), EP 0 156 993 A1, U.S. Pat. No. 4,625,845, US 2013/0206536 A1, US 2014/0309040 A1, WO 2012/101504 A1 and WO 2020/211999 A1.

In some applications, a radial arrangement of the switch segments is useful or necessary, for example if there is more space available in the drive train in terms of diameter than in terms of length. There are also flange connections on the drive side and output side. The radial arrangement of the switch segments with conventional bearings is used here. The larger the coupling is, the further away the switch segments are from the conventional bearing support, although the holding structure for the switch segments must be connected to the holding structure of the bearings. This is not a problem with smaller couplings; however, this type of design becomes more problematic the larger the couplings become:

Above a certain size, manufacturing limitations of the connection structures between the switch segments and the conventional bearing occur; such limitations can only be solved by complex and not always satisfying special designs.

The previous state of the art requires a large number of individual parts which are connected to each other via centring devices; this leads to increased imbalance.

The coupling becomes very heavy, as the connection structure between the switch segments and the conventional bearing can weigh several tonnes above a certain size, thus introducing additional loads into the overall system. This means that the overall system has to be designed larger without offering any direct added value.

The increased mass moment of inertia resulting from the increased weight must be accelerated to operating speed at every start-up or braked to a standstill. The power consumption or power output required therefor brings no added value to the application and leads to unnecessary costs.

### OBJECTS AND SUMMARY OF THE INVENTION

Starting from the above-explained disadvantages and shortcomings as well as taking the outlined prior art into account, the object of the present invention is
to reduce the connection structure between the switch segment and the conventional bearing to a minimum in order to ensure economical production;
to reduce centring to a minimum;
to reduce the volume of the connection structure to a minimum in order to minimise the load on the overall system;
to reduce the coupling cross-section is reduced so that the mass inertia of the coupling results in lower power consumption or power output.

This object is achieved by a device according to the present invention with the herein described features. Advantageous embodiments and expedient further developments of the present invention are characterized in the respective dependent claims.

This object is achieved by a Safety coupling disengaging from a drive position into a freewheel when an adjustable overload torque is exceeded in the event of an overload,
with a driving flange rotatable about an axis of rotation and comprising recesses distributed on the circumference of a hole circle, and
with a driven coupling part rotatable about the same axis of rotation,
wherein the coupling part comprises switch segments, which, in the drive position, press detent elements into the recesses under spring force, which cause a connection between the flange and the coupling part for conjoint rotation, and which, when the overload torque is exceeded, cause the release of the connection for conjoint rotation with disengagement into the freewheel, wherein each detent element is assigned a switch segment, and the detent element moves from the drive position against the spring force out of the recess into the freewheel,
wherein the flange is embodied as an inner ring allocated to a bearing or a bearing support,
wherein the coupling part is embodied as an outer ring allocated to the inner ring, and
wherein rolling elements are arranged between the inner ring and the outer ring.

This object is further achieved by an embodiment of the device according to the present invention, wherein the hole circle is arranged on a flat end face or a shell of the flange.

This object is further achieved by an embodiment of the device according to the present invention, wherein the switch segment is embodied as a spring-loaded detent ball and/or as a plunger distributed on the circumference, which can be pressed positively into the recess arranged on the flange by means of the spring force.

This object is further achieved by an embodiment of the device according to the present invention, wherein the spring force is providable by at least one disc spring.

This object is further achieved by an embodiment of the device according to the present invention, wherein the switch segment is accommodated in a housing.

This object is further achieved by an embodiment of the device according to the present invention, wherein the switch segment is arranged essentially perpendicular to the axis of rotation.

This object is further achieved by an embodiment of the device according to the present invention, wherein the switch segment is arranged pointing radially outwards.

This object is further achieved by an embodiment of the device according to the present invention, wherein the rolling elements are embodied as balls, cylinders and/or cones.

This object is further achieved by an embodiment of the device according to the present invention, wherein the inner ring and/or the outer ring comprise/comprises at least one bore or opening through which the rolling element can be inserted between the inner ring and the outer ring.

This object is further achieved by an embodiment of the device according to the present invention, wherein the bore or opening extends essentially perpendicular to the axis of rotation.

This object is further achieved by an embodiment of the device according to the present invention, wherein the bore or opening is closable by means of at least one closure means.

This object is further achieved by an embodiment of the device according to the present invention, wherein the bore or opening is closable after insertion of the rolling elements.

This object is further achieved by an embodiment of the device according to the present invention, wherein the at least one closure means is embodied as at least one plug or as at least one stopper.

This object is further achieved by an embodiment of the device according to the present invention, wherein the recesses are evenly distributed.

This object is further achieved by an embodiment of the device according to the present invention, wherein the recesses are embodied as engagement segments or as spherical caps.

This object is further achieved by an embodiment of the device according to the present invention, wherein the detent elements are embodied as detent balls.

This object is further achieved by an embodiment of the device according to the present invention, wherein the switch segments are embodied as holding devices or as detent devices.

This object is further achieved by an embodiment of the device according to the present invention, wherein the outer ring is concentrically allocated to the inner ring.

This object is further achieved by an embodiment of the device according to the present invention, wherein the rolling elements are arranged between the outer shell surface of the inner ring and the inner shell surface of the outer ring.

This object is further achieved by a use of at least one safety coupling of the type described above in a wind power station, in particular in a wind turbine, for example in its mechanical drive, such as in mechanical re-engagement.

A safety coupling embodied according to the present invention can dispense with a bearing support with a rolling bearing as a separate component. Instead, the coupling is embodied as bearing or bearing support, and the switch segments are integrated in the inner ring or inner race allocated to the bearing or to the bearing support and in the outer ring or outer race allocated, in particular concentrically allocated, to the inner ring or inner race.

The present invention thus provides a safety coupling with an integrated bearing support, wherein
the flange is embodied as an inner ring allocated to a bearing or a bearing support,
the coupling part is embodied as an outer ring allocated, in particular concentrically allocated, to the inner ring, and
rolling elements are arranged between the inner ring and the outer ring, in particular between the outer shell surface of the inner ring and the inner shell surface of the outer ring.

This has the advantage that there is no heavy connection structure between the switch segments and the bearing/the bearing support. Instead, the inner ring/inner race and the outer ring/outer race itself serve as the necessary connection structure simply due to the rolling elements (for example balls, cylinders and/or cones) arranged in between.

According to a preferred embodiment of the present invention, the hole circle can be arranged on a flat end face or a shell of the flange.

In an advantageous embodiment of the present invention, the switch segment can be embodied as a spring-loaded detent ball and/or as a plunger distributed on the circumference, which can be pressed positively into the recess arranged on the flange by means of the spring force.

According to an expedient further development of the present invention, the spring force can be providable by at least one disc spring.

In a preferred embodiment of the present invention, the switch segment can be accommodated in a housing.

According to an advantageous further development of the present invention, the switch segment can be arranged essentially perpendicular to the axis of rotation, in particular pointing radially outwards.

In an expedient embodiment of the present invention, the rolling elements can be embodied as balls, cylinders and/or cones.

According to a preferred further development of the present invention, the inner ring and/or the outer ring can comprise at least one bore or opening, in particular extending essentially perpendicular to the axis of rotation, through which the rolling element can be inserted between the inner ring and the outer ring, in particular between the outer shell surface of the inner ring and the inner shell surface of the outer ring, wherein, in particular for slewing bearings, filling of the rolling bearing tracks with rolling elements can be realised through the bore or opening on the inner ring/inner race and/or on the outer ring/outer race.

In an advantageous embodiment of the present invention, the bore or opening can, in particular after insertion of the rolling elements, be closable by means of at least one closure means, in particular by means of at least one plug or by means of at least one stopper:

After the rolling elements have been inserted, the inner ring/inner race and/or the outer ring/outer race can be closed by means of this at least one closure means, in particular by means of this at least one plug or by means of this at least one stopper.

In combination with the switch modules as safety coupling, a bearing cover, which requires a very large number of screws for fastening, thus is advantageously not necessary.

A further advantage is to be seen in a higher spring stiffness of the inner ring/inner race, as there is no weakening by screws (for example by screws M42×50, which are not unrealistic for a bearing cover of a safety coupling for 42*106 Nm). However, such screws would be superfluous with the filling method described above according to the present invention, which leads to a time saving during assembly and reduces costs, as no machine elements are necessary for a bearing cover.

The present invention finally relates to the use of at least one safety coupling of the type described above in a wind power station, in particular in a wind turbine, for example in its mechanical drive, such as in mechanical re-engagement.

An exemplary application is the so-called nacelle testing (for example dynamic nacelle testing) of large wind power stations, in particular wind turbines, on a test bench for highly accelerated lifetime tests (=HALT: this is a strongly accelerated limit load test, thus a qualitative test procedure with the aim of exposing preferably electronic and electromechanical assemblies to accelerated ageing while they are still in the development stage, in order to be able to identify weak points and design faults).

Since wind power stations are becoming ever larger and conventional safety coupling solutions are reaching their limits, here the full integration of the switch modules into slewing bearings can provide a remedy according to the invention.

### BRIEF EXPLANATION OF THE DRAWINGS

As already discussed hereinbefore, there are various possibilities for embodying and further developing the teaching of the present invention in an advantageous manner. To this end, on the one hand reference is made to the explanations above as well as to the dependent claims, on the other hand further embodiments, features and advantages of the present invention are explained in greater detail hereinafter, inter alia based upon the exemplary embodiments illustrated by FIG. 1A to FIG. 3.

It is shown in:

FIG. 1A a perspective view of a first exemplary embodiment of a safety coupling according to the present invention;

FIG. 1B a perspective sectional view of the exemplary embodiment from FIG. 1A;

FIG. 2 a perspective sectional view of a second exemplary embodiment of a safety coupling according to the present invention; and

FIG. 3 a perspective partial view of a third exemplary embodiment of a safety coupling according to the present invention.

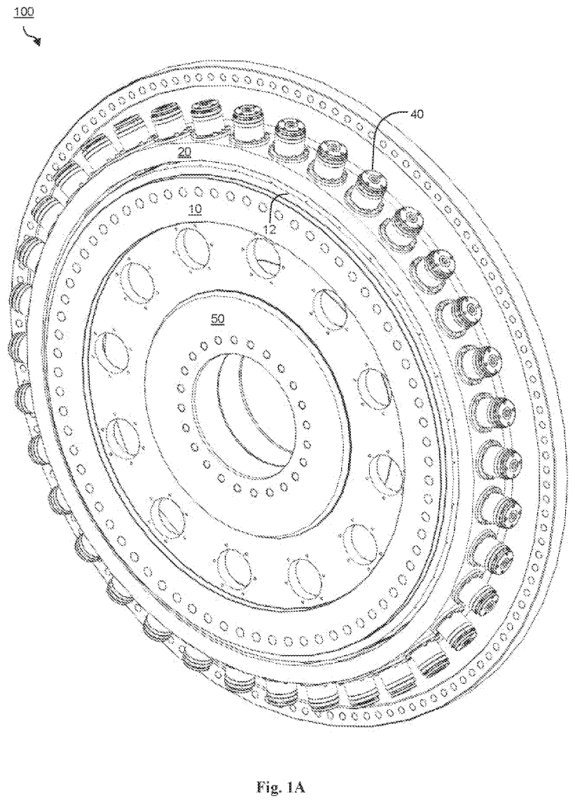

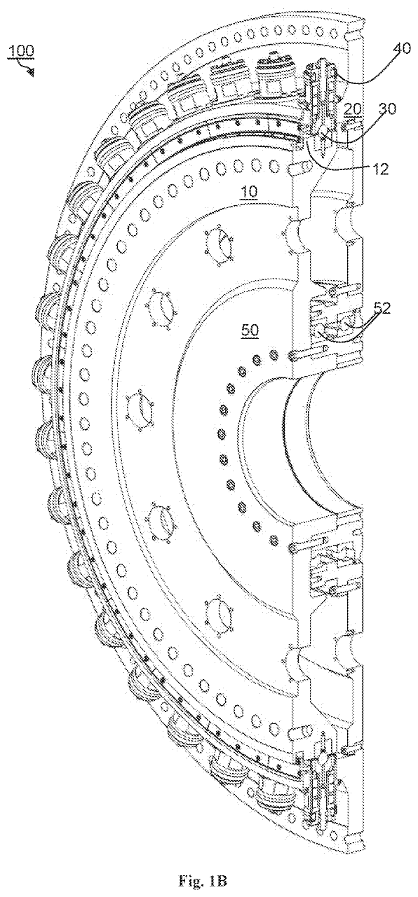

Identical, similar or matching embodiments, elements or features are labelled with the same reference signs in FIG. 1A to FIG. 3; a repeated description of these embodiments, elements or features is dispensed with. The illustrations in FIG. 1A to FIG. 3 are not necessarily true to scale; any design specifications and dimensioning specifications in FIG. 1A to FIG. 3 are purely exemplary.

### DETAILED DESCRIPTION OF THE INVENTION

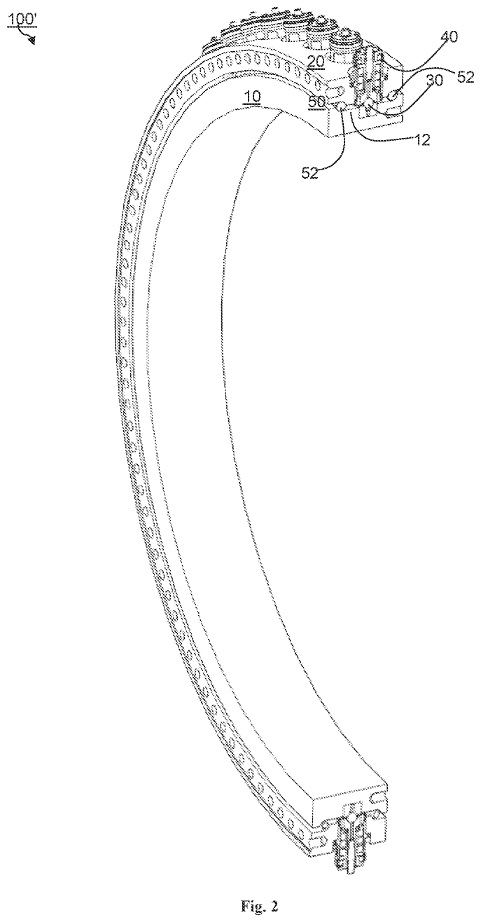

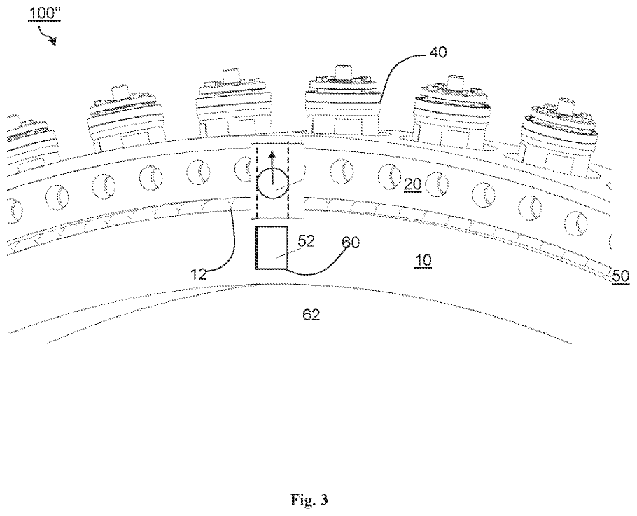

FIG. 1A to FIG. 3 respectively show an exemplary embodiment of a safety coupling 100 (=first exemplary embodiment according to FIG. 1A, FIG. 1B) or 100′ (=second exemplary embodiment according to FIG. 2) or 100″ (=third exemplary embodiment according to FIG. 3), which disengages from a drive position into a freewheel when an adjustable overload torque is exceeded in the event of an overload.

A driving flange 10 rotatable about an axis of rotation comprises recesses, in particular engagement segments or spherical caps, evenly distributed on the circumference 12 of a hole circle. A driven coupling part 20, which is rotatable about the same axis of rotation, comprises switch segments 40 in the form of holding devices or detent devices, which, in the drive position, press detent balls 30 into the recesses under spring force provided by disc springs, which cause a connection between the flange 10 and the coupling part 20 for conjoint rotation, and which, when the overload torque is exceeded, cause the release of the connection for conjoint rotation with disengagement into the freewheel, wherein each detent ball 30 is assigned a switch segment 40, and the detent ball 30 moves from the drive position against the spring force out of the recess into the freewheel.

The hole circle is provided on the flat end face or the shell of the flange 10. The switch segments 40 can be embodied either as simple spring-loaded detent elements or as several plungers distributed on the circumference, possibly with a front detent ball 30 as so-called switch segments, which are pressed positively into the recess provided on the flange 10 by means of the force of the spring.

In the event of an overload, the detent balls 30 move out of the recess in circumferential direction and at the same time in axial direction against the force of the spring and, as a holding device, cause a continuous disengagement until the safety coupling 100, 100′, 100″ is manually re-engaged by its reset element, because they remain frictionally and/or positively held in this position by locking segments, with the plunger at its free end projecting beyond the housing in the freewheel.

The plunger guided along this housing of the switch segment 40 comprises a spring generating the spring force and is characterised by moving a hydraulic piston, which separates two cylinder chambers from each other, from its rest position corresponding to the drive position into a holding position corresponding to the freewheel, thereby displacing hydraulic fluid from the one cylinder chamber into the other cylinder chamber via at least one connection comprising at least one non-return valve opening towards this cylinder chamber (and closing towards the other cylinder chamber).

To re-engage, the plunger must be returned to its drive position. In practice, this is done by striking the free end of the plunger protruding from the housing with a plastic hammer as a reset element, to release it. However, it is also important to ensure that the plunger or its detent balls 40 are opposite the recess, as this is the only way to end the freewheel and to return it to the drive position.

In some applications, such as those shown in FIG. 1A bis FIG. 3, it makes sense to align the switch segments 40 radially outwards, i.e. essentially perpendicular to the axis of rotation, especially if there is more space available in the drive train in diametrical direction than in axial direction. There is also a customer-side flange connection on the drive side and the output side.

Therefor, when the switch segments 40 are arranged radially, the (rolling) bearing or the (rolling) bearing support 50 is not embodied as separate component, but the safety coupling 100 (=first exemplary embodiment according to FIG. 1A, FIG. 1B) or 100′ (=second exemplary embodiment according to FIG. 2) or 100″ (=third exemplary embodiment according to FIG. 3) is embodied as a bearing, namely in this way,
that the flange 10 is embodied as an inner ring/inner race allocated to the bearing or the bearing support 50,
that the coupling part 20 is embodied as an outer ring/outer race concentrically allocated to the inner ring, and
that rolling elements 52, in particular balls, cylinders and/or cones, are arranged between the inner ring and the outer ring, in particular between the outer shell surface of the inner ring and the inner shell surface of the outer ring.

The switch segments 40 are integrated in the inner ring/inner race and in the outer ring/outer race.

This provides a safety coupling 100′ (=second exemplary embodiment according to FIG. 2) or 100″ (=third exemplary embodiment according to FIG. 3) with an integrated bearing, which has the advantage that there is no heavy connection structure between the switch segments 40 and the bearing/bearing support 50. Instead, the inner ring/inner race and the outer ring/outer race itself serve as a necessary connection structure simply because of the rolling elements 52.

FIG. 3 illustrates that, in particular for slewing bearings, the rolling bearing tracks are filled with the rolling elements 52 through a bore or opening 60 on the inner ring/inner race (, alternatively or additionally also on the outer ring/outer race) extending perpendicular to the axis of rotation. After the rolling elements 52 are inserted through the bore or opening 60 between the outer shell surface of the inner ring and the inner shell surface of the outer ring, the bore or opening 60 of the inner ring/inner race (, alternatively or additionally also the bore or opening of the outer ring/outer race) is closed by a closure means 62 in the form of a plug or stopper. Consequently, in combination with the switch modules 40 as safety coupling, a bearing cover, which requires a very large number of screws for fastening, is not necessary.

A further advantage is to be seen in a higher spring stiffness of the inner ring/inner race, as there is no weakening by screws (for example by screws M42×50, which are not unrealistic for a bearing cover of a safety coupling for 42*106 Nm). However, such screws are superfluous with the filling method described above according to the present invention, which leads to a time saving during assembly and reduces costs, as no machine elements are necessary for a bearing cover.

An exemplary application is the so-called nacelle testing (for example dynamic nacelle testing) of large wind power stations, in particular wind turbines, on a test bench for highly accelerated lifetime tests (=HALT: this is a strongly accelerated limit load test, thus a qualitative test procedure with the aim of exposing preferably electronic and electromechanical assemblies to accelerated ageing while they are still in the development stage, in order to be able to identify weak points and design faults). Since wind power stations are becoming ever larger and conventional safety coupling solutions are reaching their limits, here the full integration of the switch modules 40 into slewing bearings can provide a remedy.

### LIST OF REFERENCE NUMERALS

100 safety coupling (=first exemplary embodiment according to FIG. 1A, FIG. 1B)
100′safety coupling (=second exemplary embodiment according to FIG. 2)
100″ safety coupling (=third exemplary embodiment according to FIG. 3)
10 flange
12 circumference of flange 10
20 coupling part
30 detent element, in particular detent ball
40 switch module or switch segment, in particular holding device or detent device
50 bearing or bearing support, in particular rolling bearing or rolling bearing support
52 rolling element, in particular ball or cone or cylinder, of bearing or bearing support 50
60 bore or opening
62 closure means, in particular plug or stopper, for bore or opening 60

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. Safety coupling disengaging from a drive position into a freewheel when an adjustable overload torque is exceeded in the event of an overload,
with a driving flange rotatable about an axis of rotation and comprising recesses distributed on the circumference of a hole circle, and
with a driven coupling part rotatable about the same axis of rotation,
wherein the coupling part comprises switch segments, which, in the drive position, press detent elements into the recesses under spring force, which cause a connection between the flange and the coupling part for conjoint rotation, and which, when the overload torque is exceeded, cause the release of the connection for conjoint rotation with disengagement into the freewheel, wherein each detent element is assigned a switch segment, and the detent element moves from the drive position against the spring force out of the recess into the freewheel,
wherein the flange is embodied as an inner ring allocated to a bearing or a bearing support,
wherein the coupling part is embodied as an outer ring allocated to the inner ring, and
wherein rolling elements are arranged between the inner ring and the outer ring.

2. Safety coupling according to claim 1, wherein the hole circle is arranged on a flat end face or a shell of the flange.

3. Safety coupling according to claim 1, wherein the switch segment is embodied as a spring-loaded detent ball and/or as a plunger distributed on the circumference, which can be pressed positively into the recess arranged on the flange by means of the spring force.

4. Safety coupling according to claim 1, wherein the spring force is providable by at least one disc spring.

5. Safety coupling according to claim 1, wherein the switch segment is accommodated in a housing.

6. Safety coupling according to claim 1, wherein the switch segment is arranged essentially perpendicular to the axis of rotation.

7. Safety coupling according to claim 6, wherein the switch segment is arranged pointing radially outwards.

8. Safety coupling according to claim 1, wherein the rolling elements are embodied as balls, cylinders and/or cones.

9. Safety coupling according to claim 1, wherein the inner ring and/or the outer ring comprise/comprises at least one bore or opening through which the rolling element can be inserted between the inner ring and the outer ring.

10. Safety coupling according to claim 9, wherein the bore or opening extends essentially perpendicular to the axis of rotation.

11. Safety coupling according to claim 9, wherein the bore or opening is closable by means of at least one closure means.

12. Safety coupling according to claim 11, wherein the bore or opening is closable after insertion of the rolling elements.

13. Safety coupling according to claim 11, wherein the at least one closure means is embodied as at least one plug or as at least one stopper.

14. Safety coupling according to claim 1, wherein the recesses are evenly distributed.

15. Safety coupling according to claim 1, wherein the recesses are embodied as engagement segments or as spherical caps.

16. Safety coupling according to claim 1, wherein the detent elements are embodied as detent balls.

17. Safety coupling according to claim 1, wherein the switch segments are embodied as holding devices or as detent devices.

18. Safety coupling according to claim 1, wherein the outer ring is concentrically allocated to the inner ring.

19. Safety coupling according to claim 1, wherein the rolling elements are arranged between the outer shell surface of the inner ring and the inner shell surface of the outer ring.

20. Use of at least one safety coupling according to claim 1 in a wind power station or in a wind turbine.
